(19) United States
(12) Patent Application Publication
(10) Pub. No.: US 2009/0037209 A1
(43) Pub. Date: Feb. 5, 2009

(54) Packaging Specification

(76) Inventors: Karen Schulze, Heidelberg (DE); Matthias Nater, Rauenberg (DE); David Strobl, Walldorf (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/096,356

(22) PCT Filed: Dec. 5, 2005
(86) PCT No.: PCT/EP2005/056492

§ 371 Date: Aug. 25, 2008

(51) Int. Cl. G06Q 10/00

(52) U.S. Cl. 705/1

(57) ABSTRACT

An interface between a packaging system and a data storage device which stores a plurality of packaging specifications, for selecting at least one packaging specification out of the plurality of packaging specifications, the interface comprising a plurality of input parameters and at least one output parameter, wherein each input parameter receives a search key, and the interface triggers the selection of at least one packaging specification according to the received search key and the output parameter provides the at least one selected packaging specification. The selected packaging specifications are applied to several packaging systems, for example packaging machines.

### BACKGROUND OF THE INVENTION

The present invention relates to systems and methods for managing packaging processes within one or more e-business systems. More particularly, the present invention relates to systems and methods for controlling packaging systems.

### STATE OF THE ART

Many companies make use of a supply chain management system to control and optimize their production, warehouse management and delivery processes.

Supply chain management comprises the process of controlling the flow of goods, services, information and/or finances between the involved parties such as manufactures, suppliers, wholesalers, retailers, and consumers. This process may include, among others, order processing, information feedback, packing the products and timely delivering the ordered goods and/or services.

In supply chain management a frequent problem is to pack products such that transportation costs, storage costs and/or the required space in the warehouses are minimized. Warehouse workers have to decide how the products have to be packed and which packaging materials have to be used. With several thousand products in a warehouse this task cannot be performed optimally.

### SUMMARY OF THE INVENTION

In general, in one aspect, this invention provides an interface between a packaging system and a data storage which stores a plurality of packaging specifications, for selecting at least one packaging specification out of the plurality of packaging specifications, the interface comprising a plurality of input parameters and at least one output parameter, wherein each input parameter receives a search key, and the interface triggers the selection of at least one packaging specification according to the received search key and the output parameter provides the at least one selected packaging specification.

The interface may provide a uniform access to a plurality of packaging specification.

Furthermore, the interface may be accessible by a plurality of packaging systems or by a plurality of computer systems. Different packaging systems such as packaging machines and different computer systems, for example, warehouse management systems may use the uniform interface for accessing and selecting the required packaging specifications.

In a second aspect, this invention provides a computer-implemented method for controlling a plurality of packaging systems, whereby packaging is specified in a packaging specification and the method includes the steps of:
receiving, via the input parameter of the interface, search keys identifying a packaging specification;
searching a plurality of packaging specifications for a packaging specification according to the search keys; and

transmitting, via the output parameter of the interface, the packaging specification to the packaging system.

The packaging system may be controlled by at least one packaging specification which is selected according to a number of search keys which are provided by the packaging system. Different packaging systems may provide different search keys depending, for example, on their field of business.

In one embodiment of invention, the plurality of packaging specifications are stored in at least one data storage, whereby a plurality of data storages are replicated after predefined time intervals.

Several data storages may be located with several locations. Each data storage can be managed independently. Changes on the packaging specifications, e.g. new packaging specifications or removed packaging specifications, may be replicated after predefined time intervals or synchronously and in real time.

Each packaging specification may be identifiable by a plurality of business keys.

Furthermore, a packaging specification may comprise:

a header element comprising organizational attributes;

a plurality of condition records comprising a plurality of business keys;

a plurality of content records comprising products to be packed;

a plurality of levels comprising packing instructions and a plurality of level elements, the level elements comprising packaging materials or working steps; and

further packaging specification.

Thus, a packaging specification provides all necessary information for the packaging system how an in which quantity the products have to be packed. A packaging specification may provide also information about additional working steps to be carried out before or after packing the products. In one embodiment, a packaging specification comprises a further packaging specifications. This way, hierarchical packaging specifications may be specified.

Searching a plurality of packaging specifications may be carried out using the business keys and the search keys.

In a third aspect of the invention, a method for packing products within a packaging process is provided whereby the method comprises at least the steps of:

determining a number of search keys;

selecting a packaging specification by passing the search keys to the input parameter of the interface according to claim 1;

applying the selected packaging specification to the packaging process.

In one embodiment, applying the selected packaging specification to the packaging process further comprises a step of extracting the relevant parts of the packaging instructions out of the packaging specification. Since the packaging specification provides data—the packaging instructions—for different packaging systems, the packaging system may extract the relevant data. For example, working steps may be relevant for a packaging system but not for an availability check process which uses the same packaging specification.

In this embodiment, applying the selected packaging specification to the packaging process is carried out by a packaging machine.

In a further aspect, the invention provides a system for packing products according to at least one packaging specification, comprising:

at least one data storage device which stores a plurality of packaging specifications;

at least one packaging system which packs the products;

at least one interface between the at least one data storage device and the at least one packaging system; and

means which select at least one packaging specification out of the plurality of packaging specifications.

The at least one interface may perform the following steps:

receiving a plurality of search keys from the at least one packaging system;

triggering the selecting means;

providing the at least one selected packaging specification to the packaging systems.

The advantage of the packaging specification is that it can be integrated in a plurality of logistic processes. The product flow from a supplier to a warehouse or from a warehouse to a customer can be optimized, such that less shipping costs occur or a better availability of products can be ensured. As the packaging specification can be replicated in several data storages, e.g. with several supply chain management systems, further applications or packaging systems might use the packaging specification in the future. By using business keys for identifying packaging specifications the amount of packaging specifications can be kept as small a possible and at the same time, the business keys allows full flexibility.

### BRIEF DESCRIPTION OF DRAWINGS

The accompanying drawings, which constitute a part of this disclosure, illustrate various embodiments and aspects of the present invention and, together with the description, explain the principles of the invention.

FIG. 1 illustrates a supply chain management system with one single interface and a centralized data storage;

FIG. 2 illustrates a supply chain management system with several interfaces and several decentralized data storages;

FIGS. 3a and 3b illustrate the structure of a packaging specification;

FIG. 4 illustrates an exemplary business scenario;

FIG. 5 illustrates the method of controlling packaging systems according to the invention; and

FIG. 6 illustrates the method for packing products of according to the invention.

### DETAILED DESCRIPTION

Packaging specifications describe how and in which quantity products have to be packed in order to be shipped to a customer. A packaging system, which may be a part of a supply chain management system, determines such a packaging specification out of a plurality of packaging specifications and provides for packing the products as prescribed by the determined packaging specification. One example for a packaging system is a packaging machine. Within the supply chain, several packaging systems may use the same packaging specifications for the same products. The packaging systems may be located at different locations or with different participants of the supply chain, e.g. manufacturers, suppliers or contract packagers.

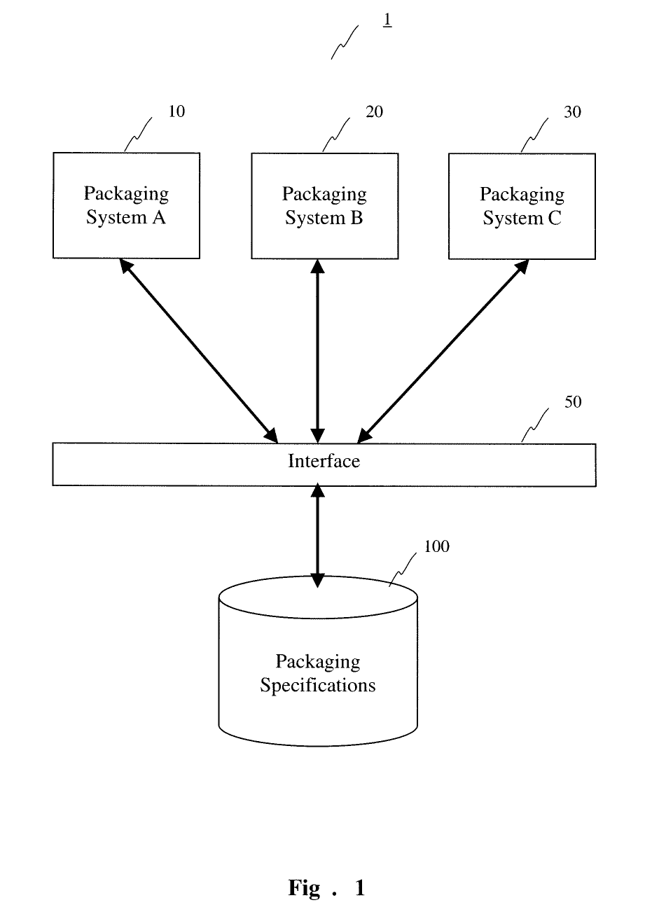

FIG. 1 illustrates by way of example a first embodiment of the invention. A supply chain management system may comprise three separate packaging systems 10, 20, 30. A plurality of packaging specifications are stored centralized in data base 100. The supply chain management system further comprises an interface 50 for accessing the plurality of packaging specifications for the packaging systems 10, 20, 30. The packaging system 10, for example, is located with a manufacturer, the packaging system 20 is located with a contract packager and the packaging system 30 is located with a supplier. In order to provide the same packaging specifications for each packaging system, the packaging systems 10, 20, 30 use the interface 50 for accessing packaging specifications in database 100.

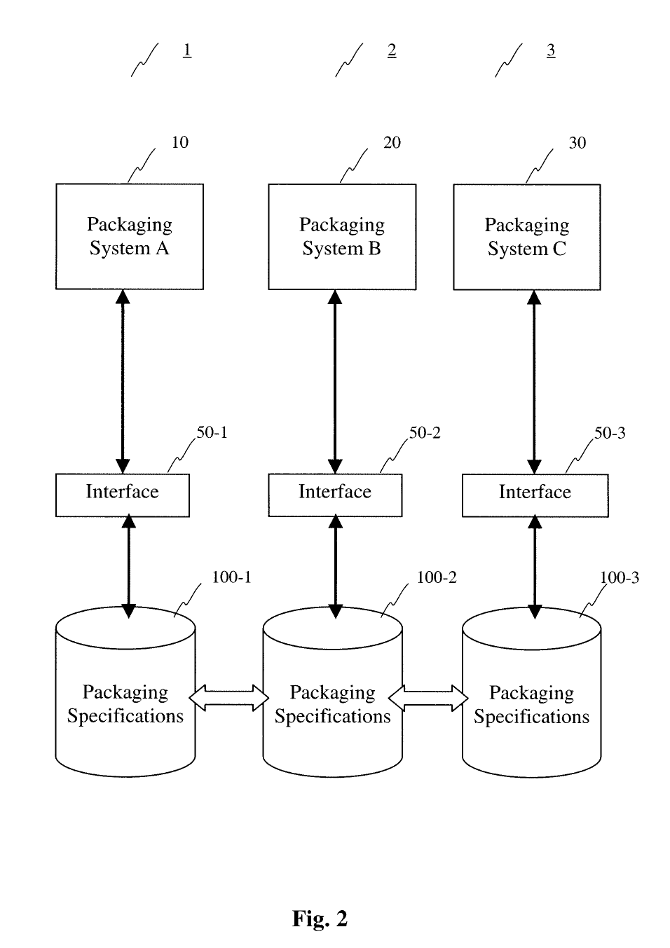

According to a second embodiment of the invention the packaging specifications are stored in several decentralized data bases 100-1, 100-1, 100-3 as illustrated in FIG. 2. The databases may be located with different supply chain management systems. The first supply chain management system, for example, is located with the manufacturer, the second supply chain management system is located with the contract packager and the third supply chain management system is located with the supplier. Each supply chain management system 1, 2, 3 provides an interface 50-1, 50-2, 50-3 for accessing the packaging specifications. To guarantee that all the packaging systems 10, 20, 30 can use the same packaging specifications, the packaging specifications are replicated between the databases 100-1, 100-2, 100-3. The data replication between the data storages may be done either synchronously or asynchronously.

According to the invention, the interface 50 provides a plurality of input parameters and at least one output parameter. The input parameters of the interface 50 receive search keys from the packaging system. These search keys may be business keys, for example product location, customer or order type. After receiving the search keys the interface triggers a process for selecting a packaging specification according to the search keys. The selected packaging specification is returned through the output parameter to the packaging system. Then the packaging system applies the packaging specification to the packaging process and provides for packing the product according to the packaging instructions of the packaging specification.

Each packaging specification provides a plurality of packaging instructions. The packaging systems have to decide which of the available packaging instructions is to be used for packing the products. Thus, a packaging specification may provide instructions for several different systems, for example for a packaging machine or for an availability check process. The packaging machine uses the packaging specification for packing the products according to the packing instructions of the packaging specification. The availability check process may use the packaging specification for checking availability of products according to a plurality of rounding rules which may also be a part of a packaging specification.

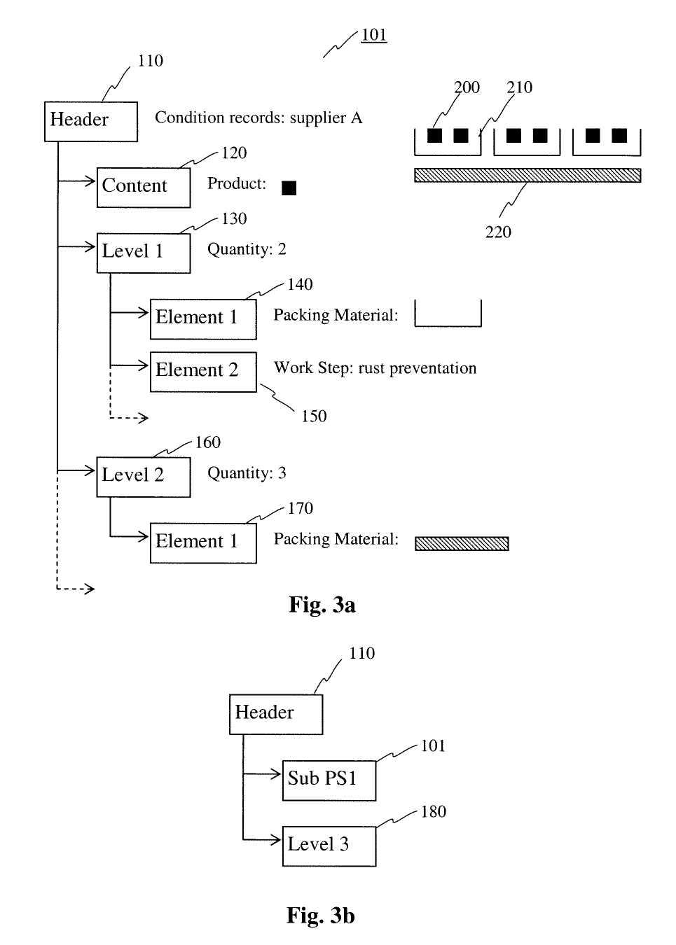

FIG. 3a shows the structure of a packaging specification 101. The packaging specification 101 comprises:
header 110,
content 120,
a plurality of levels 130, 160, and
a plurality of level elements 140, 150, 170.

These four elements are described in the following.

The header 110 comprises several organizational attributes, for example an identifier, date of creation and the name of the packaging engineer who designed and created the packaging specification. A plurality of condition records are assigned to the header 110. The condition records may be a set of business keys which specify for which the packaging specification applies, for example supplier, warehouse or product. These condition records, in one embodiment, are used for selecting the corresponding packaging specification by the selection process.

The content 120 comprises several basis attributes which are necessary for packing products. Such an attribute may store the product 200 which has to be packed according to the packaging specification.

Each level element 140, 150, 170 is assigned to a level 130, 160, whereby a level may consist of a plurality of level elements.

Each level 130, 160 comprises information on how the product, specified in the content element, has to be packed. The corresponding level elements 140, 150 and 170 specify which packaging material 210 and 220 has to be used for packaging the products. Additionally, the level elements may comprise further instructions, such as a wok step which may be performed during packing the product. For example, if the product must get rust prevention before packed, “rust prevention” is stored as work step with the level elements.

The sequence of packing a product is given by the sequence of the levels 130, 160. The packaging specification according to FIG. 3a specifies the following packaging instructions:

First, product 200 has to be packed in pairs (quantity: 2 of level 130) into a carton (packaging material 210 of level element 140). Before packing into the cartons the products into the cartons, the products receive rust prevention (work step: rust prevention of level element 150).

Within the next packaging step according to the level 160, three of these cartons (quantity: 3 of level 160) have to be packed into a container 220 (packaging material 220 of level element 170).

Such a packaging specification may also be used for checking the availability of a required quantity of products according to a customer order. For example, a packaging specification may be used for controlling several packaging systems or for controlling an availability check process of a required quantity of products. In the latter case the attributes of the levels of the packaging specification may additionally store several rounding rules, if the results of the availability check have to be rounded.

Furthermore, the packaging specification may also be used to support the customer order process. If a customer orders products 200 according to the above mentioned example, the order system can access the packaging specification 101 and can advise the customer to order in multiples two (carton). If a distributor wants to increase his stock level, the order system can advise the distributor to order in multiples of six (container).

A packaging specification may also be used as a part of another packaging specification. This way, the packaging specification may be defined hierarchically. FIG. 3b shows a packaging specification whereby item 101 is the packaging specification as shown in FIG. 3a. Therefore, the packaging specification may be reused for creating and defining new packaging specifications. The number of packaging specifications within a supply chain management system may be reduced. Further, redundant data may be avoided by reusing packaging specifications.

The usage of the business keys is very flexible. One packaging system might use product and location as search keys, whereas a second packaging system product and supplier. Both pairs of keys may lead to the same packaging specification but it is also possible that both pairs of keys lead to two different packaging specifications. Furthermore, the product flow from one location to another, for example from warehouse to customer or from supplier to warehouse, may be optimized, such that less transportation costs occur and/or a better availability of products can be ensured.

Which business keys are passed to the interface 50, depends on the packaging systems and on the business keys which are available with the packaging systems. It might be possible that a contract packager does not maintain customers as business keys because customer data is not of interest for a contract packager.

In a further embodiment of the invention, the process for selecting a packaging specification which is triggered by the interface after receiving the search keys may perform the selection of the packaging specification based on a condition technique. The condition technique provides means for selecting a set of packaging specifications according to a plurality of parameters, for example product and location or other customer related properties. Therefore, the packaging specifications may depend on various customer or order related properties or further business attributes.

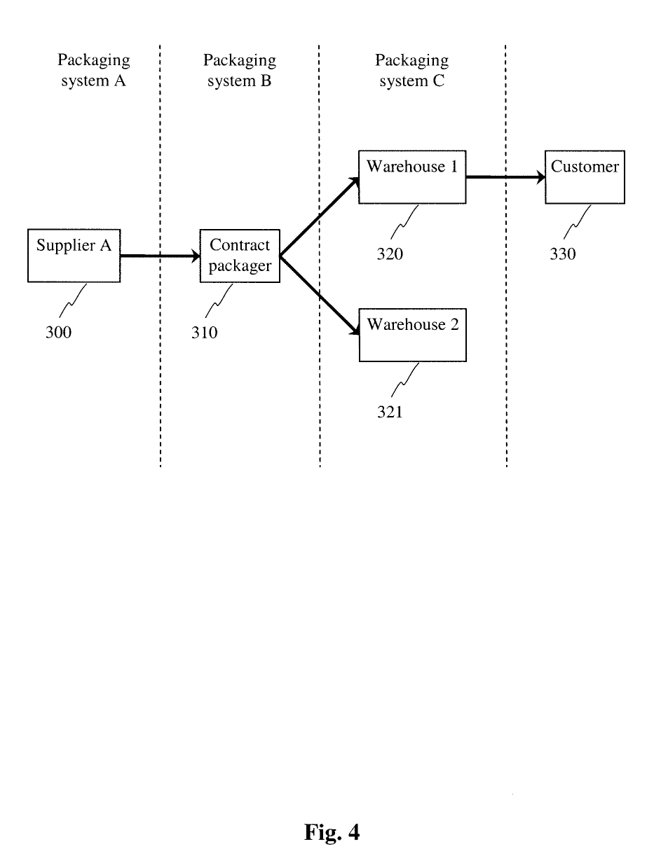

In the following, a business scenario is given which describes the usage of several packaging specifications for one product in three different packaging systems. An overview of this scenario is shown in FIG. 4.

The Product “piston” is first shipped from supplier A 300 to a contract packager 310. The product is then packed such that it can last for several years in a warehouse without loosing its functionality. When the contract packager has finished the pistons are deployed to warehouses 320 and 321. Finally, the product is shipped from warehouse 320 to a customer 330.

The supplier 300 uses a packaging system A, the contract packager a packaging system B, and the warehouses use a packaging system C. The packaging systems apply different packaging specifications to the packaging process for the same product “piston”, whereby the packaging specifications are provided by one single data storage. The data storage is accessed through the above mentioned interface using several business keys as search keys.

In this business scenario the following packaging specifications for product “piston” are provided:
Packaging specification A with business keys “Supplier: A, Product: Piston” and the packaging instructions “up to 2000 pistons are shipped in a container”.
Packaging specification B with business key “Product: Piston” and the packaging instructions “One piston is packed into a carton after rust prevention has taken place. 36 cartons are stapled on a wood pallet and the load is then secured with a special steel band”.
Packaging specification C with business keys “Product: Piston, Route: Airfreight” and the packaging instructions “Use the special packaging material “aircarton” for 1 to 5 pistons”.

The supplier A 300 creates an advanced shipping notification of 900 pistons to the contract packager 310. The automatic packaging system with the supplier A 300 packs all 900 pistons into one container by applying packaging specification A. The container is the shipped to the contract packager 310.

Upon arriving of the container at the contract packager 310 the packaging specification B is applied. With the value-added service order the pistons receive rust prevention and each piston is packed by the packaging system into a carton. 36 of these cartons are packed on a wood pallet and secured by a steel band. After checking the demands at warehouse 320 (200 pistons) and at warehouse 321 (1100 pistons) the contract packager or the packaging system decides to ship 6 pallets to warehouse 320 (216 pistons) and 9 pallets to warehouse 321 (684 pistons).

Some time later, a customer 330 orders three pistons. As the customer order has the route “airfreight”, packaging specification C is applied by the packaging system with the warehouse 320. Therefore the packaging system packs the three pistons into a special “aircarton”. Packing of the products according to the packaging specification may be also done by a warehouse worker.

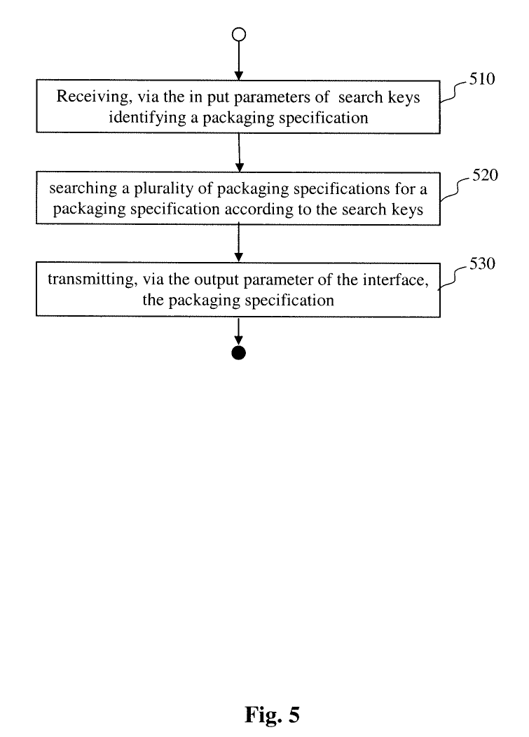

FIG. 5 summarizes the method of controlling packaging systems according to an embodiment of the invention. The method begins with receiving, via the input parameter of the interface of the invention, search keys identifying a packaging specification, see step 510. Then, in step 520, a plurality of packaging specifications are searched for a packaging specification according to the search keys. The packaging specification found in the search step is transmitted, via the output parameter of the interface to the packaging system, see step 530.

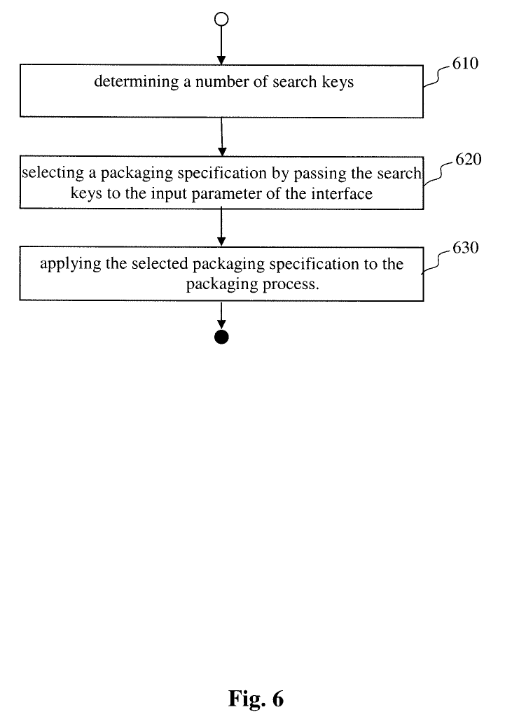

FIG. 6 summarizes the method of for packing products of according to an embodiment of the invention. This method comprising the steps of: Determining a number of search keys, see step 610. In step 620, a packaging specification is selected by passing the search keys to the input parameter of the interface according the invention. Then, in step 630, the selected packaging specification is applied to the packaging process.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

1. An interface between a packaging system and a data storage which stores a plurality of packaging specifications, to select at least one packaging specification out of the plurality of packaging specifications, the interface comprising a plurality of input parameters and at least one output parameter, wherein each input parameter receives a search key, and the interface to trigger the selection of at least one packaging specification based on the received search key and the output parameter to provide the at least one selected packaging specification.

2. The interface of claim 1, wherein the interface is accessible by a plurality of packaging systems.

3. The interface of claim 2, wherein the interface is furthermore accessible by a plurality of computer systems.

4. A computer-implemented method for controlling a plurality of packaging systems, to specify packaging in a packaging specification, the method comprising:
receiving search keys identifying a packaging specification via an input parameter of an interface between a packaging system and a data storage which stores a plurality of packaging specifications, to select at least one packaging specification out of the plurality of packaging specifications, the interface including a plurality of input parameters and at least one output parameter;
searching the plurality of packaging specifications for a packaging specification according to the search keys; and
transmitting, via the output parameter of the interface, the packaging specification to the packaging system.

5. The computer-implemented method of claim 4, wherein the plurality of packaging specifications are stored in at least one data storage.

6. The computer-implemented method of claim 5, further comprising:
replicating the plurality of data storages are replicated after predefined time intervals.

7. The computer-implemented method of claim 6, wherein each packaging specification is identifiable by a plurality of business keys.

8. The computer-implemented method of claim 7, wherein the packaging specification comprises:
a header element comprising organizational attributes;
a plurality of condition records comprising a plurality of business keys;
a plurality of content records comprising products to be packed;
a plurality of levels comprising packing instructions and a plurality of level elements, the level elements comprising packaging materials or working steps; and
further packaging specification.

9. The computer-implemented method of claim 7, wherein searching a plurality of packaging specifications is carried out using the business keys and the search keys.

10. A method for packing products within a packaging process, the method comprising:
determining a number of search keys;
selecting a packaging specification by passing the search keys to the input parameter of an interface between a packaging system and a data storage which stores a plurality of packaging specifications, the interface including a plurality of input parameters and at least one output parameter, wherein each input parameter receives a search key, the interface to trigger the selection of at least one packaging specification based on the received search key and the output parameter to provide the at least one selected packaging specification; and
applying the selected packaging specification to the packaging process.

11. The method of claim 10, wherein applying the selected packaging specification to the packaging process further comprises:
extracting the relevant parts of the packaging instructions out of the packaging specification.

12. The method of claim 11, wherein applying the selected packaging specification to the packaging process is carried out by a packaging machine.

13. A system for packing products according to at least one packaging specification, comprising:
at least one data storage device which stores a plurality of packaging specifications;
at least one packaging system which packs the products;
at least one interface between the at least one data storage device and the at least one packaging system; and
means which select at least one packaging specification out of the plurality of packaging specifications;
wherein the at least one interface:
receives a plurality of search keys from the at least one packaging system;
triggers the selecting means; and
provides the at least one selected packaging specification to the packaging systems.
